(19) United States
(12) Patent Application Publication
(10) Pub. No.: US 2013/0198598 A1
(43) Pub. Date: Aug. 1, 2013

(54) SECURE POPULATION OF FORM DATA

(71) Applicant: OneID Inc., Redwood City, CA (US)

(72) Inventor: STEVEN TODD KIRSCH, Los Altos Hills, CA (US)

(73) Assignee: OneID Inc., Redwood City, CA (US)

(21) Appl. No.: 13/745,318

(22) Filed: Jan. 18, 2013

Related U.S. Application Data
(60) Provisional application No. 61/609,848, filed on Mar. 12, 2012.
(60) Provisional application No. 61/609,853, filed on Mar. 12, 2012.
(60) Provisional application No. 61/588,084, filed on Jan. 18, 2012.

(51) Int. Cl. G06F 17/24

(52) U.S. Cl. CPC G06F 17/243
USPC 715/226; 715/224

(57) ABSTRACT

A method of populating form data may include accessing an electronic form provided by a website. The electronic form may include a plurality of fields. The method may also include using the plurality of fields to request information associated with the plurality of fields from an identity repository and receiving the information associated with the plurality of fields from the identity repository. The method may additionally include using the information associated with the plurality of fields to populate the plurality of fields of the electronic form.

### CROSS-REFERENCES TO RELATED APPLICATIONS

This application claims priority to the following three U.S. Provisional Patent Applications, and the entire disclosure of each of these applications are incorporated by reference into this application for all purposes:
U.S. Provisional Patent Application No. 61/609,848, filed Mar. 12, 2012 entitled “Methods and Systems for Secure Identity Management” (Attorney Docket No. 94276-833770(000400US)); and
U.S. Provisional Patent Application No. 61/609,853, filed Mar. 12, 2012 entitled “Methods and Systems for Populating Form Data”, (Attorney Docket No. 94276-834282(000900US));
U.S. Provisional Patent Application No. 61/588,084, filed Jan. 18, 2012, entitled “Single Identification for Transactions” (Attorney Docket No. 94276-840013(001300US)).

The following five regular U.S. patent applications (including this one) are being filed concurrently, and the entire disclosure of the other applications are incorporated by reference into this application for all purposes:
U.S. patent application Ser. No. ______, filed Jan. ______, 2013, entitled “Methods and Systems for Secure Identity Management” (Attorney Docket No. 94276-840939(000410USNP));
U.S. patent application Ser. No. ______, filed Jan. ______, 2013, entitled “Methods and Systems for Pairing Devices” (Attorney Docket No. 94276-847941(000710USNP));
U.S. patent application Ser. No. ______, filed Jan. ______, 2013, entitled “Methods and Systems for Device Disablement” (Attorney Docket No. 94276-849686(001010USNP));
U.S. patent application Ser. No. ______, filed Jan. ______, 2013, entitled “Secure Population of Form Data” (Attorney Docket No. 94276-861349(000910US)); and
U.S. patent application Ser. No. ______, filed Jan. ______, 2013, entitled “Secure Graphical Code Transactions” (Attorney Docket No. 94276-832681(000110US)).

### BACKGROUND

Personal computing devices have become an important part of the retail landscape. Smart phones, tablet computers, laptops, and personal computers are being used by large segments of the population to engage in retail, banking, and communication transactions. By necessity, these transactions require identity verification and communication security in order to avoid compromising sensitive data. Therefore, sensitive data has to either be remembered by a user or stored somewhere on a computing device. Sensitive data is often lengthy and complicated, and thus, it is unwieldy for users to be expected to remember and enter this information reliably.

Just as personal computing devices have recently gained popularity for engaging in secure transactions, attackers and malware creators have seized on this fertile new ground for criminal purposes. Users often have viruses and other types of malware operating on their user devices without their knowledge. These malicious software processes can often compromise the widespread use of specialized banking and communication software to gain access to personal information. This personal information can be transmitted to a distant location and exploited long before users know their data has been compromised.

One particular vulnerability of online transactions may arise when filling out web forms with personal information. Users may have to slowly fill this information out by hand each time it is used, which may allow the data to be easily viewed by a malicious nearby actor. Also, repeatedly filling out the same information each time a transaction is made is an error-prone process that can result in inadvertent purchases, incorrect shipping information, and/or incorrect billing. Therefore, improvements are needed in the art.

### BRIEF SUMMARY

The present invention relates generally to online, or virtual identities. More specifically, the present invention relates to methods and systems for using virtual identities to populate form data. Merely by way of example, the invention has been applied to a method of securely transferring personal information from a remote repository to a web form of a relying party. The methods and techniques can be applied to a variety of transactions, interactions, and identity management systems.

In one embodiment, a method of populating form data may include accessing an electronic form provided by a website. The electronic form may include a plurality of fields. The method may also include using the plurality of fields to request information associated with the plurality of fields from an identity repository and receiving the information associated with the plurality of fields from the identity repository. The method may additionally include using the information associated with the plurality of fields to populate the plurality of fields of the electronic form.

In another embodiment, a method of populating form data may include providing, to a user device, an electronic form comprising a plurality of fields. The method may also include providing, to the user device, a mapping that associates the plurality of fields to information stored in an identity repository. The method may additionally include receiving, from the user device, the information stored in the identity repository.

In yet another embodiment, a method of populating form data by an identity repository may include receiving, from a user device a request for information associated with fields of an electronic form and an identifier of a website providing the electronic form to the user device. The method may also include determining whether permission has previously been granted to provide the information to the website. The method may additionally include obtaining, in response to a determination that permission has not previously been granted, permission from the user device to provide the information to the website. The method may further include providing the information to the user device.

Numerous benefits can be achieved by way of the present invention over conventional techniques. For example, embodiments of the present invention reduce the likelihood that malicious actors can intercept form data during a transaction. Additionally, embodiments of the present invention provide a system for reducing errors and inconveniences that may be introduced during manual information entry. These and other embodiments along with many of their advantages and features are described in more detail in conjunction with the text below and attached figures.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a simplified block diagram of an exemplary identity management system, according to one embodiment.

FIG. 2 illustrates a simplified block diagram of key storage for an identity management system, according to one embodiment.

FIGS. 3A-3B illustrate a simplified interface of an electronic form, according to one embodiment.

FIG. 4 illustrates a simplified block diagram of a workflow for generating a mapping, according to one embodiment.

FIG. 5 illustrates a simplified swim diagram of transactions that may be involved with populating fields in an electronic form, according to one embodiment.

FIG. 6 illustrates a simplified flowchart of a method of populating an electronic form from the perspective of a user device, according to one embodiment.

FIG. 7 illustrates a simplified flowchart of a method of populating an electronic form from the perspective of a website, according to one embodiment.

FIG. 8 illustrates a simplified flowchart of a method of populating an electronic form from the perspective of an identity repository, according to one embodiment.

FIG. 9 illustrates a block diagram of components for an exemplary operating environment in which various embodiments of the present invention may be implemented.

FIG. 10 illustrates a block diagram of an exemplary computer system in which embodiments of the present invention may be implemented.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Described herein, are embodiments for securely populating an electronic form. Electronic forms may be implemented in various ways, the most common of which being a web form. Electronic forms are used in many online transactions and mobile purchasing applications. Generally, any time that one party needs to receive information that is manually entered by another party, an electronic form may be used to define the types of information being requested.

Electronic forms offer numerous advantages and provide a recognizable interface that online consumers have grown accustomed to. Electronic forms may be used to request personal information such as identification, names, addresses, shipping addresses, billing addresses, credit card information, credit card numbers, credit card verification (CCV) numbers, organizations, titles, Social Security numbers, birth dates, transaction amounts, bank account numbers, routing numbers, personal identification numbers (PINs), passwords, usernames, e-mail addresses, telephone numbers, hardware identification (ID) numbers, and/or the like. The embodiments discussed herein may be used to populate electronic forms using any type of information in addition to the information listed above.

Despite their popularity and ease of use, electronic forms may pose risks to both consumers and merchants. Consumers may be vulnerable to an over-the-shoulder eavesdropping attack if they fail to properly shield their computer screen from nearby onlookers. Consumers may also enter incorrect information by misspelling words, mixing up fields, or failing to provide information for required fields. On the merchant side, incorrectly entered information may result in erroneous orders, shipments to the wrong location, incorrect contact information, and other problems.

Additionally, electronic forms often request personal information related to secure bank accounts and credit card payment systems. Because PINs, passwords, credit card numbers, and other types of secure identifiers may be difficult to remember, consumers may carry written copies of this information that can be used to populate electronic form fields. This written information can be misplaced or compromised, which may either prevent consumers from making valid transactions or result in fraudulent transactions if the written information is found by someone with malicious intent.

Instead of writing down their sensitive information, some consumers may make the more serious mistake of storing their sensitive information on their computing devices. It has been discovered that malware and other types of viruses may easily be configured to search for sensitive information on a computing device. Password files may be compromised and transmitted to an attacker resulting in fraudulent use of a consumer's banking information.

Even if consumers can safely remember their sensitive information without writing it down and can reliably populate electronic forms using their sensitive information, this process may represent an inconvenience. Depending on the size of the electronic form, this inconvenience may deter consumers from making purchases. The prospect of filling out contact information, business information, shipping addresses, billing addresses, usernames, passwords, credit card information, and/or the like, every time a consumer wants to make a purchase may simply be overwhelming or inconvenient for many consumers.

The embodiments described herein may be used to solve these and many other problems related to populating electronic forms. In some embodiments, a secure repository, also referred to as an identity repository, may be used to store sensitive information for consumers. The identity repository may be remotely located geographically away from users at a secure location. The sensitive information at the identity repository may be encrypted, and the cryptographic keys needed to access the sensitive information may be stored at a separate physical location, such as on a user device. When populating an electronic form, a user device may request certain information related to a user from the identity repository, and this information may be used to populate the electronic form fields.

In some embodiments, the user device may receive a command from a user to auto populate an electronic form provided by a website using information stored at the identity repository. The user device may send a list of field identifiers (e.g. name, credit card number, shipping address, etc.) to the identity repository to be retrieved. The identity repository may determine whether permission was previously received to release information of this type to the website providing the electronic form. If permission was not previously received, the identity repository may request permission to be granted from the user device. The user device can receive permission from a user and transmit an indication of that permission to the identity repository. The identity repository can then send the information associated with the field identifiers to the user device, and the user device can populate the electronic form fields with the information. In some embodiments, the information may be encrypted when sent and decrypted by the user device.

In some embodiments, the website may provide a mapping of field identifiers in the electronic form. The mapping may associate field identifiers used by the website to repository identifiers used by the identity repository. In other words, the website may provide its own instructions on how the identity repository may be used to auto populate the electronic form. The mapping may be provided to the user device along with the electronic form. In some embodiments, the mapping may comprise an attribute map in a web scripting language. These embodiments will be described in greater detail later in this disclosure.

This disclosure is divided into three sections. First a basic overview of a secure identity management system will be provided. This secure identity management system can be used to store sensitive information away from a user device and provide that information when needed to populate an electronic form. Next, exemplary embodiments of the present invention will be presented. These embodiments will illustrate how to populate an electronic form using a mapping provided by a website and/or an identity repository using secure sensitive information. Finally, an exemplary hardware system will be provided comprising network computing devices that can be used to implement the various embodiments disclosed herein.

### Secure Identity Management

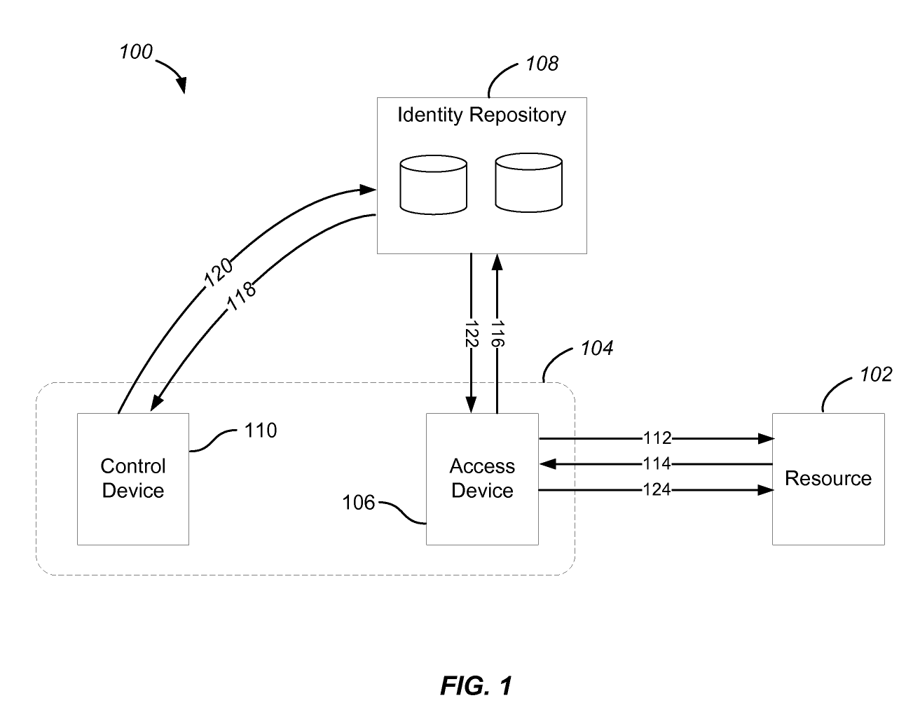

FIG. 1 illustrates a simplified block diagram 100 of a system for online identity management, according to an embodiment of the present invention. The system may be configured to use one or two user devices. At its most basic level, the system can use an access device 106. The access device 106 will typically be the device the user is using for an interaction. Second, an optional control device 110 may be used. The control device 110 may comprise a personal device, such as a smart phone, tablet computer, personal computer, and/or personal digital assistant (PDA) that is controlled by the user. Additionally, a remotely located identity repository 108 can be used in the interaction. The access device 106 can engage in the interaction with a resource 102. The resource can include a website, a database, a web service, and/or the like. Man-in-the-middle attacks can be reduced because cryptographic secrets can be transferred from user controlled endpoint devices securely, even if the identity repository is compromised by an attacker.

In this embodiment, the access device 106 (AD) may comprise a user device that is being authenticated to perform a transaction using a virtual identity. The control device 110 (CD) may comprise a second user device in the user's control that is used to set access rights for the users access device 106 and to perform OOB authentication/verification. The resource 102 (RP) may be defined as a party, typically a website, to which the user wishes the virtual identity to be authenticated and, optionally, with which to share attributes and perform additional transactions. The identity repository 108 (Repo) may be defined as an online database of encrypted credentials and attribute/value pairs. The identity repository 108 may be remotely located and may be operated by a third party that is not associated with either the user or the resource 102. Each access device 106 and control device 110 may have a unique identifier, referred to as a Device ID (DEVID). Additionally, each user may have a unique identifier, or Global User ID (GUID), that is stored on the access device 106 and on the control device 110 and can be used to index information stored on the identity repository 108. Finally, each user may have a second user identification (UID) that comprises a site-specific identifier for the user for the resource 102. The UID can be derived at least in part from the fully-qualified domain name associated with the resource 102.

In one embodiment, the access device 106 and the identity repository 108 can be required in order to complete a transaction. The control device 110 can be a separate device from the access device 106, or the same physical device can be used as both the access device 106 and the control device 110. For example, a laptop can function as both the access device 106 and the control device 110. A mobile phone could also function as both devices. Participation by the control device 110 may optionally be required in a transaction to provide a higher level of assurance that the user has consented to the transaction. This process will be described further below. At any time, the user may choose to use a higher security mode comprising a higher level of assurance. The user can also choose to lock out any individual device or force the individual device into a higher security mode. These actions can be performed on any device registered by the user. Furthermore, some embodiments may employ a special “tripwire” feature so that, if a password or PIN is not entered when requested, a device will be prevented from supplying any subsequent digital signatures until the requested password or PIN is provided.

As used herein, transactions may use a varying “Level of Assurance” (LoA) mode. In one embodiment, four modes are supported: disabled, enabled with no security, password with a timeout, and out-of-band (OOB) authorization required with an optional PIN and timeout. Users can control the LoA mode required by each type of transaction. To minimize risk in the case of a lost user device, devices can be immediately turned off from any remaining registered device that the user still controls. In one embodiment, the identity repository 108 can enforce the greater of two LoA modes: the level requested by the user and the level requested by the resource 102. This can ensure that organizations, such as financial institutions, can be compliant with regulations regardless of the security level requested by the user. For example, a bank could require that, for transaction to be approved, a PIN should be entered on the control device 110 within a time period, such as 5 minutes. For banks, two factor authentication may be required by FFIEC regulations.

According to one embodiment, the conditions in an LoA mode may be based on information related to the devices owned or operated on behalf of the user or devices authorized for the user with limits on how devices can be used in the transaction. For example, a desktop computer in a secure work area may have a higher transaction value limit than a mobile device. A mobile device with a password-to-unlock feature may have a higher transaction value limit than an unlocked mobile device. One of ordinary skill in the art would recognize many variations, modifications, and alternatives.

The conditions in an LoA mode can include information related to preferences established by one of the parties, including transaction value limits, time periods during which transactions are initiated, geographic locations where the transaction is initiated, histories of returns or invalidated transactions, user reputations, number of transactions within a particular time period, or the like. The conditions in an LoA mode can also include cumulative data, including thresholds for the number of items in a single purchase, cumulative costs of items in a single transaction, cumulative amount spent in a particular time period, and/or the like. Therefore, the conditions in an LoA mode can comprise a cost threshold for a single transaction, a cumulative cost threshold for transactions during a time period, or a time limit since a password was provided to a user device. These conditions can be used to define almost every aspect of a transaction/interaction, such that a party can set specified authentication levels that add security to high-value transactions or transactions where the risk of fraud is high. It should be noted that if preferences received from a party contradict preferences already stored on the device executing this method, the more conservative or secure preferences can be used in the transaction.

According to one embodiment, the conditions in an LoA mode may also include conditions related to types of transactions. For example, purchasing certain types of goods, such as jewelry, cars, software, collectibles, or the like, that are more likely to be involved in theft and fraud can require higher levels of authentication. The conditions can also include conditions on payment options. For example, purchasing items with a credit card may require a first authorization level, while paying for items with a debit card may require a second authorization level. The preferences can also include conditions on methods of shipping or shipping locations. For example, shipping items to a Post Office Box or to an address different from the billing address may require a higher authorization level.

Each of the conditions of an LoA mode may be associated with one or more authentication levels. If the condition is met, then the specified authentication level (or a higher authentication level) should be used in the transaction/interaction. An authentication level can comprise requiring an indication that the transaction is approved to be received by a user module operating on a user device. For example, a user may be required to provide input indicating that they have reviewed the transaction and approve. An authentication level can also comprise notifying additional devices that are associated with the user. For example, a notification can be sent to a user's cell phone or tablet computer for a transaction that was initiated on the user's desktop computer. An authentication level can comprise requiring a PIN or password to be received by one or more of the additional devices associated with the user, such as a control device. An authentication level can comprise a waiting period between initiating the transaction and final approval. In one embodiment, an authentication level may require human contact by a representative of the relying party. In another embodiment, an authorization level can require a third-party to authenticate the transaction, such as the identity repository.

In one embodiment, an LoA mode can also specify a timeout period associated with each PIN and/or password. For example, one mode could specify that a password should be entered into the access device within the last three hours preceding the transaction/interaction. As another example, one mode could specify that a PIN should be entered into the control device within five minutes preceding the transaction interaction. The timeout period may be affected by other factors, such as the time of day of the transaction, a cost associated with the transaction, the security of the device used in the transaction, a cumulative cost of a set of transactions, and/or any other factors described above. For example, a timeout period may be longer on a secure device, whereas the timeout period may be shorter on an insecure device.

What follows is a brief description of one exemplary transaction. Each step in this exemplary transaction will be discussed in more detail later in this disclosure. Returning to block diagram 100 of FIG. 1, the access device 106 can access the resource 102 (112). In response, the resource 102 can return a random digital challenge and request that the access device 106 return the challenge signed by two or three signatures (114). Next, the access device 106 can generate one or more cloud repository keys. The access device 106 can pass the digital challenge and the one or more cloud repository keys to the identity repository 108 (116). If the access device 106 is password protected and a timeout period is exceeded, the user may supply digital proof that the user knows the password to the access device 106. The digital proof may comprise a guess of the password. In one embodiment, the digital proof is not transmitted off of the access device 106, not even in a hashed or encrypted form. Confirmation that the user knows the password is provided by signing a challenge from the identity repository 108.

The identity repository 108 can compare a first LoA mode specified by the access device 106 with a second LoA mode specified by the resource 102 to determine whether an OOB approval should also be required for the transaction. If an OOB approval is determined to be required by either the access device 106 or the resource 102, the identity repository 108 sends a challenge to the control device 110 (118). In one embodiment, certain details of the original transaction can be displayed to the user on the control device 110, thus eliminating the possibility of a man-in-the-browser attack or a man-in-the-middle attack. A PIN can also be requested by the control device 110. If a PIN has not been provided within a timeout period, the control device 110 may prompt the user to enter the PIN. In one embodiment, any PIN guess entered by the user never leaves the control device 110. Instead, the control device 110 can rely on asymmetric cryptography and another challenge from the identity repository 108 to prove to the identity repository 108 that the user has supplied the correct PIN. This process will be described further later in this disclosure. Approval for the transaction, along with any signed challenges, can be sent back to the identity repository 108 (120). In one embodiment, the control device 110 signs the challenge from the resource 102 using a private key stored on the control device 110.

The identity repository 108 can enforce the LoA mode on the transaction. Therefore, the identity repository 108 can withhold its signature on the challenge unless all of the requirements of the LoA mode have been met. If the identity repository 108 determines that all of these requirements have been met, the identity repository 108 can sign the challenge using its private key. The identity repository 108 can then send the signature of the control device 110 and the signature of the identity repository 108 to the access device 106 (122). At this point, the access device 106 can sign the challenge and return all two/three signatures to the resource 102 (124). Additionally, the access device 106 can send a user ID (the site-specific user ID). The resource 102 can look up a set of public keys that are associated with the UID to verify that all three signatures correspond to the public keys and grant access to the user. In one embodiment, the public keys can be unique to the resource 102. In other words, each website will be associated with its own set of public and private key pairs. This can assure a user's privacy and prevent website tracking. Because the resource 102 interacts with the access device 106, the identity repository 108 can be prevented from determining which resources the user has visited. The identity repository 108 simply holds an encrypted block of data and receives commands to read and write encrypted keys and values.

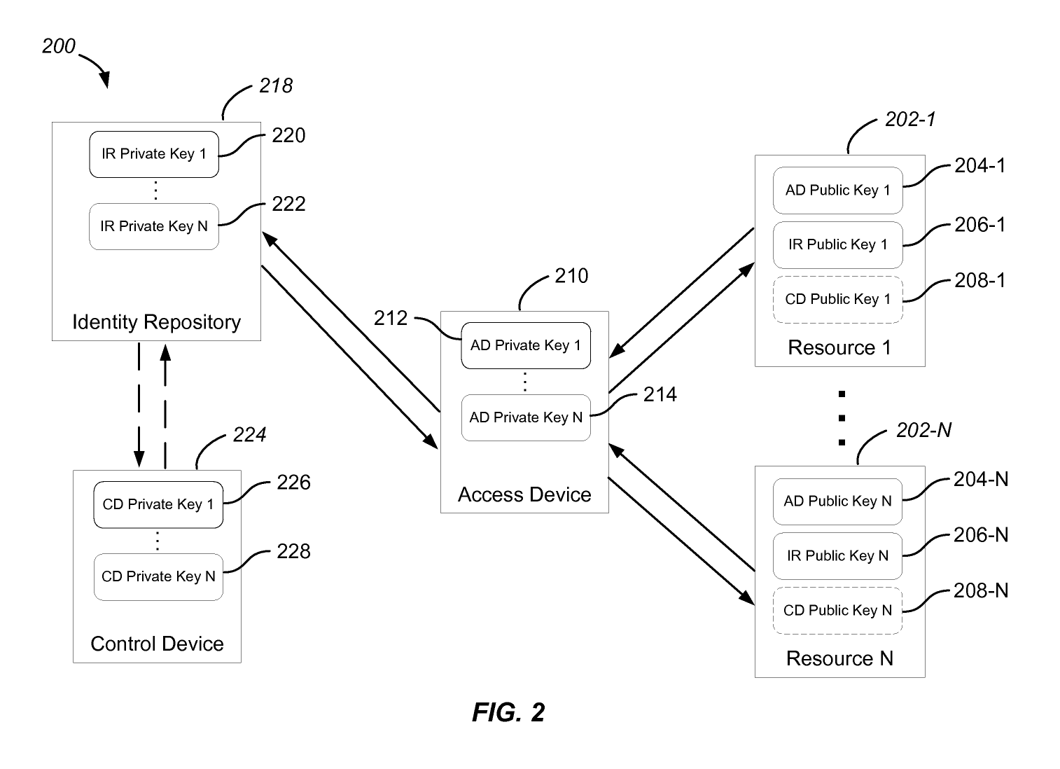

FIG. 2 illustrates a simplified block diagram 200 of a system for online identity management with distributed secrets, according to an embodiment of the present invention. The embodiment of FIG. 2 uses a subset of the keys that may be used by various embodiments of the identity management system. Note that the remaining keys may be operative in the background of the system illustrated by FIG. 2. Additionally, the keys in FIG. 2 may be derived from one or more of the keys not explicitly shown in FIG. 2. As described earlier, an access device 210 may engage in a transaction with a number of resources 202. Each of the resources 202 may have a set of public keys associated with a UID of a user of the access device 210. For example, resource 202-1 stores two to three public keys for the UID 210, namely an AD public key 204-1 that is associated with the access device 210, an IR public key 206-1 that is associated with an identity repository 218, and, optionally, a CD public key 208-1 that is associated with a control device 224.

When the access device 210 first attempts a transaction with one of the resources 202, the access device 210 can provide the public keys 204, 206, 208 to the resources 202. Each of the resources 202 may have a unique set of public keys. In providing the public keys 204, 206, 200, the access device 210 may create the AD public keys 204, and the IR public keys 206 and the CD public keys 208 can be obtained from the identity repository 218 and the control device 224, respectively.

When initiating a transaction, the resources 202 can send a digital challenge to the access device 210 to authenticate a virtual identity. When the LoA mode requirements of each device of been met, each device may sign the digital challenge using the private keys that correspond to the public key of the particular resource. For example, a digital challenge sent from resource 202-1 could be signed by the access device 210 using AD private key 212 and the identity repository 218 using the IR private key 220. Optionally, the digital challenge could also be signed by the control device 224 using the CD private key 226. Each of these devices may enforce one or more requirements of the LoA mode before signing. For example, the control device 224 may require a PIN from the user, and the identity repository 218 may require an OOB authorization from the control device 224. The access device 210 may require a signature from the identity repository 218 as well as a signature from the control device 224 before signing the digital challenge. Other embodiments may enforce different requirements as described elsewhere herein.

In one embodiment, each of these keys are actually stored on their respective devices. In another embodiment, a master key is stored and each device from which the keys in FIG. 2 are deterministically derived when they are needed. For example, the AD private key 212 may be derived from an Access Device Key (ADK) for the access device 210.

The “transactions” referred to in the above discussion should be interpreted broadly. In some cases, a transaction may involve a commercial purchase. In other cases, a transaction may simply involve retrieving securely stored information from the identity repository and decrypting the information at the user device for use by the user device, such as populating an electronic form. A full description of the identity management system can be found in U.S. patent application Ser. No. ______, filed concurrently on Jan. ______, 2013, entitled “Methods and Systems for Secure Identity Management” (Attorney Docket No. 94276-840939(000410USNP)), which is incorporated by reference for all purposes as stated above.

### Electronic Form Population

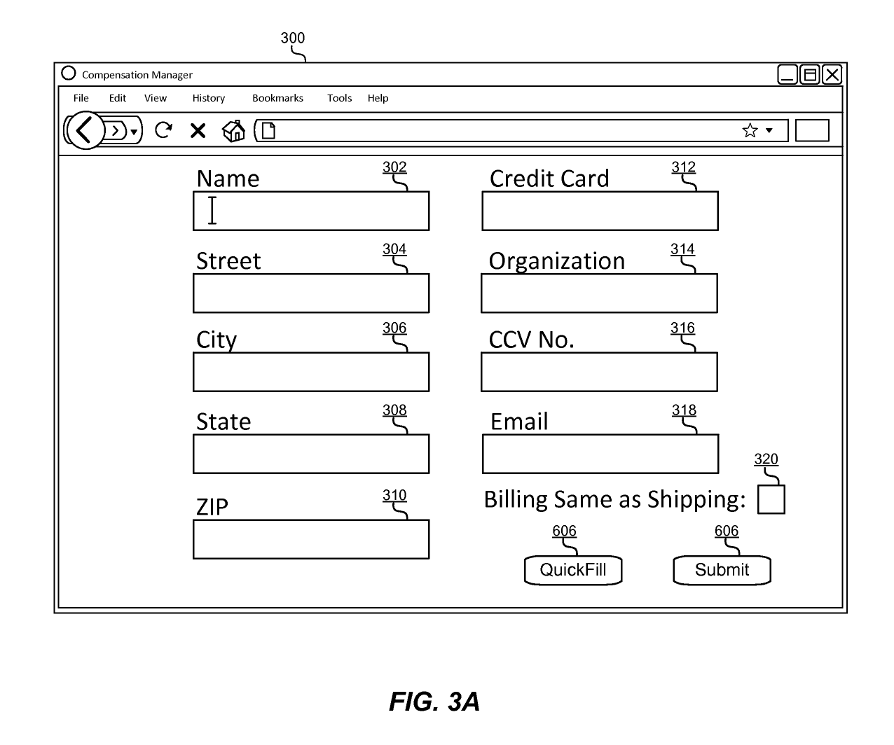

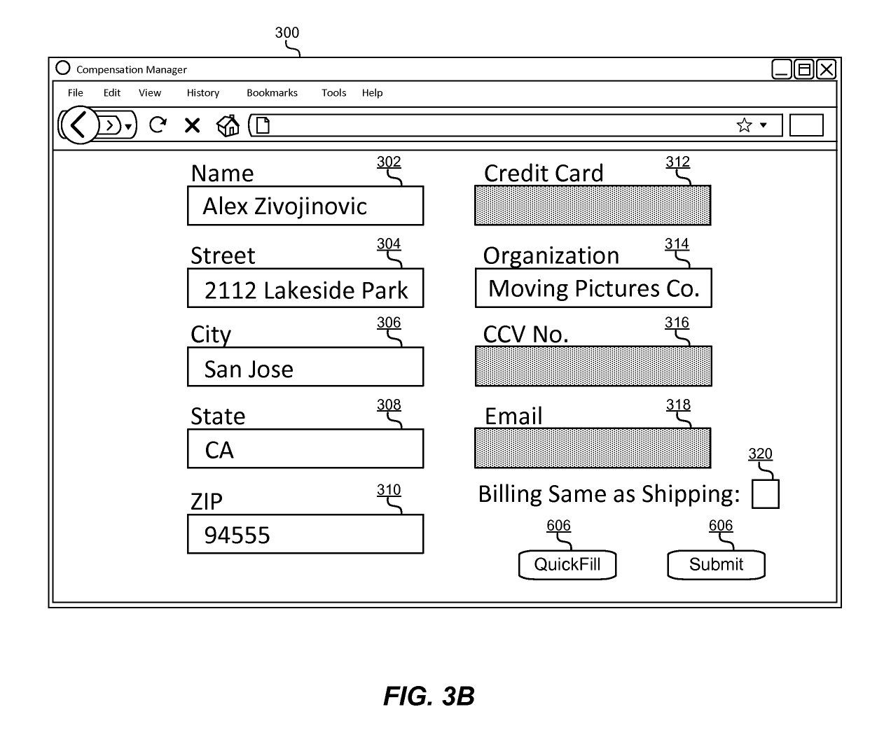

FIG. 3A illustrates a simplified interface for an electronic form, according to one embodiment. In this embodiment, the interface may be implemented using a web browser 300. In other embodiments, similar interfaces may be implemented using an application (app) on a smart phone or tablet computer, an application on a desktop computer or laptop computer, and/or the like. The web browser 300 displays an electronic form that includes a plurality of fields. In this particular embodiment, the fields may include a name field 302, a street field 304, a city field 306, a state field 308, a zip code field 310, a credit card field 312, an organization field 314, a CCV number field 316, and/or an e-mail field 318. The fields displayed in a web browser 300 are merely exemplary and not meant to be limiting. Many other field types may be used. Also, these fields are depicted as text boxes; however, other types of common form controls may be used. For example, a checkbox 320 may be used to select various options, such as specifying that the billing address is the same as the shipping address. Other controls available on a web form may include radio buttons, groups, drop-down boxes, menus, selections, buttons, signature areas, and/or the like. The fields and controls illustrated in web browser 300 may be rearranged, added to or subtracted from, and otherwise adapted to the particular needs of each embodiment.

In some embodiments, an electronic form may include a submit button 606 that submits information entered into each of the fields and controls to the website providing the electronic form. Some embodiments may also include a “QuickFill” button 606 to activate some of the methods described herein that automatically populate the electronic form. The label “QuickFill” is merely exemplary, and other names such as “AutoFill”, “AccuFill”, “RapidFill”, or “SmartFill” may be used, along with any other name that conveys a similar meaning to a user.

In some embodiments, a user may select the “QuickFill” button 606 to automatically retrieve information from an identity repository, decrypt the information if necessary, and use the information to populate the plurality of fields in the electronic form. In some embodiments, a “QuickFill” button 606 may not be necessary. In these embodiments, the web browser 300 may be configured to automatically detect that the user device is logged into an account on the identity repository, and may automatically extract the information, decrypt it if necessary, and populate the electronic form.

A webpage embodying the electronic form may be downloaded from a relying party, such as a merchant website, a banking institution, a social network, and/or the like. The webpage may include code that is executed by the web browser 300 on the user device. In some embodiments, JavaScript may be used. The code executed by the web browser 300 may make intelligent decisions regarding the information provided from the identity repository when filling in the web form. For example, the code may instruct a processor to determine that a billing address provided from the identity repository is the same as a shipping address. In this case, checkbox 320 may be checked by the web browser 300.

Many existing websites may wish to utilize the functionality provided by the embodiments discussed herein. In order to retrofit an existing electronic form, small modifications may be made to the HTML and JavaScript code used to create the electronic form. In the examples described herein, the current assignee (OneID®) may be used as an example. One having skill in the art could take these examples and change the URLs, libraries, and/or references to accommodate other identity repositories.

In some embodiments, a website owner may simply add client and/or form-fill script tags to an existing website. For example, the following script tags may be added:

<script src=″https://api.oneid.com/js/includeexternal.js”
type=″text/javascript″></script>
<script src=″https://api.oneid.com/form/form.js″
type=″text/javascript″></script>

Next, the website may provide a mapping of field identifiers associated with each field in the electronic form to a set of repository identifiers provided by the identity repository. The identity repository can make a standardized listing of repository identifiers available for participating websites. An example of this mapping function will be described further below.

Additionally, a website may add a “QuickFill” button 606 using images and code provided by the identity repository. For example, the following code may be added to an existing HTML webpage:

<img
onclick = “OneIdForm.fill (myAttributeMap);”
src = “https://api.oneid.com/images/oneid_quickfill.png” />

This code can be configured to instruct a user device to display a button as a part of the electronic form in such a way that it identifies the function of the button, and possibly the operator of the identity repository that will be used, which in this case is the current assignee (OneID®). In some embodiments, the “QuickFill” button 606 may include a logo or other graphic illustration.

When the user device retrieves information from the identity repository and populates the electronic form, this information may be automatically submitted, or may be manually submitted by clicking the submit button 606. FIG. 3A illustrates a simplified interface for a populated electronic form, according to one embodiment. This particular interface illustrates the same electronic form as FIG. 3A, except some of the fields have been populated with information from an identity repository. Here, fields that have not been populated by the identity repository are highlighted, such as credit card field 312, CCV number field 316, and e-mail field 318.

In some cases, the electronic form may request information or include fields that do not correspond to information stored in the identity repository. Clicking the “QuickFill” button 606 may populate the electronic form fields as thoroughly as possible, and a user may be required to fill in the remaining fields. In other embodiments, the web browser 300 may highlight the fields that have been populated with information from the identity repository, while leaving the remaining fields unhighlighted.

In some embodiments, the user may enter the information into the remaining fields 312, 316, 318 for example, and the web browser 300 may include code that detects this new information. The new information may then be sent to the identity repository to be stored according to the mapping provided by the website. In some embodiments, the user may be provided with the opportunity to approve storing the newly-entered information in the identity repository. The user may select some or all of the information manually entered into the electronic form.

In some embodiments, the information in the remaining fields 312, 316, 318 may be automatically filled-in with information stored on the user device. For example, some web browsers may include the ability to save form information locally on the user device. The form may supplement the information stored locally on the user device with information retrieved from the identity repository. Alternatively, the information retrieved from the identity repository may be supplemented with any information stored locally on the user device. In some embodiments, the information stored locally on the user device and used to complete the web form may then be stored in the identity repository according to the mapping provided by the website.

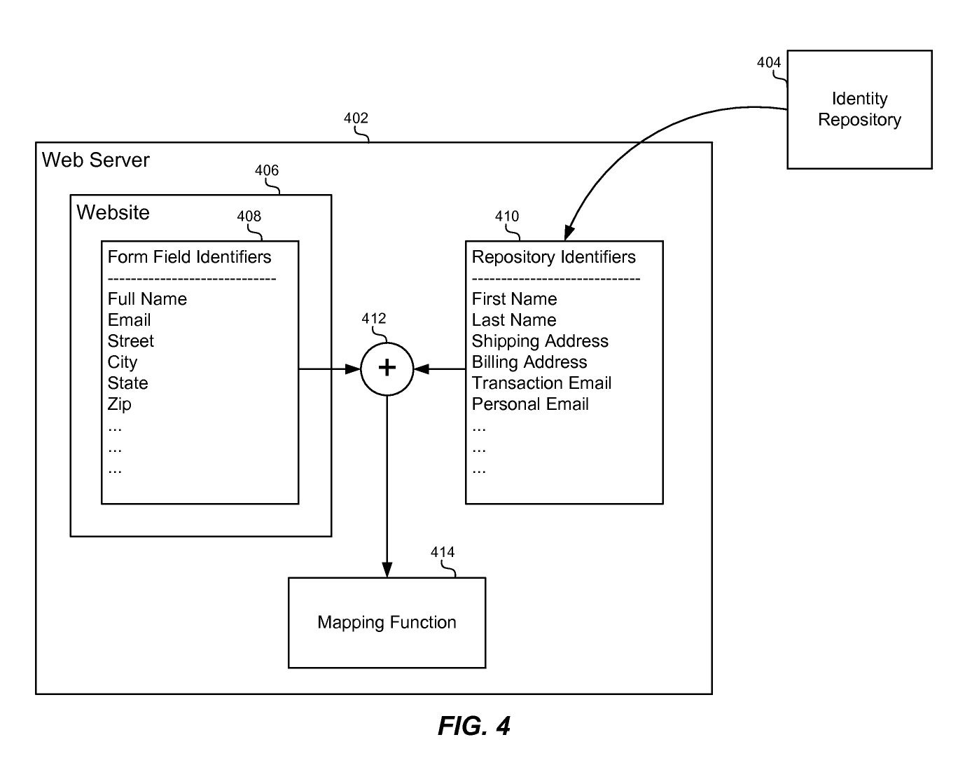

FIG. 4 illustrates a simplified block diagram of a workflow for generating a mapping, according to one embodiment. A web server 402 may be operated by a relying party, such as a merchant, financial institution, social network, and/or the like. The web server may provide a website 406 that includes an electronic form. The electronic form may include control such as text boxes, drop-down menus, and/or the like. Each of the controls in the electronic form may be associated with an identifier. As used herein, these identifiers may be referred to as “field identifiers” 408 and may be used to identify text fields as well as other types of controls, such as buttons, radio boxes, and so forth. For example, an HTML document may define text box inputs as follows:

<p><label for=“user_email”> Email: </label>
<input type=“text” id=“user_email”></p>
<p><label for=“full_name”> Full name: </label>
<input type=“text” id=“full_name”> </p>

In this example, text boxes are instantiated for a user e-mail and a full name. The field identifiers 408 associated with these text boxes are user_email and full_name, respectively. These field identifiers 408 may be used to reference the controls within the HTML document. Generally, the field identifiers 408 are created by the website author, and may not match the format or identifier used by the identity repository.

In order to generate a mapping, the identity repository 404 may provide a known set of repository identifiers 410 and formats. The website provider may then use the repository identifiers 410 to create a mapping 414 that can be used to associate information requested by the electronic form with information stored in the identity repository 410. In some embodiments, the mapping 414 may be a pairing between one or more field identifiers 408 and one or more repository identifiers 410. The mapping may be also be referred to as a mapping function.

Using the e-mail and full name text boxes in the example above, one particular embodiment of a mapping function may be included in the webpage code as follows:

var myAttributeMap =

{ “formData” :

{ “user_email” : { “oneid_attribute” : “personal_info[email]”,

“selector_type” : “id” },

“full_name” : { “oneid_attribute” :
“personal_info[first_name],

personal_info[last_name]”, “format”:
“data[‘personal_info[first_name]’] + \” \“ +
data[‘personal_info[last_name]’]”,
“selector_type” : “id” } }

};

Here, the full name field identifier will be associated with the personal_info [first_name] repository identifier and the personal_info [last_name] repository identifier. Also, the user_email field identifier will be associated with the personal_info [email] repository identifier. The example above uses the JavaScript dictionary “Attribute Map” with a single entry labeled “formData”. In other words, this is a dictionary that lists inputs to be populated in the electronic form. The key for each property is the selector for the input and the value contains the parameters specifying how the form should be populated for each input control in the electronic form.

The name and e-mail examples above are fairly simple. The full_name input will be populated with a concatenation of the user's first and last names. More complicated and advanced string manipulation may also be used to combine, divide, or otherwise manipulate various form fields and repository fields to create the mapping 414. In this particular embodiment, each element in the mapping also includes an attribute list and a selector type that specifies how the selector for the input will be populated. The selector type may choose between, for example, the field ID or name.

Each element may also include a format which specifies either a function that takes the attribute values and returns a string for the value or a format string for concatenating values in the input. The formatting can be applied to the data before it is used to fill in the form. A format function may receive a single parameter that contains a dictionary of the attributes requested for the particular input. Each item in the dictionary may be accessed by its attribute path, within the dictionary, for example:

function myFormatter(data) {

return data[‘personal_info[first_name]’] + “ ” +
data[‘personal_info[lastname]’];

}

Here, the format string may be evaluated in a context where the variable “data” includes the dictionary of attributes. In some cases, the preceding function and the format string in the attribute map can perform similarly.

Some embodiments may also use more advanced controls, each of which can be used in the mapping. For example, radio buttons may be set by the automatic population of the form if the value of the radio button matches the value of the repository identifier mapped to that input. This matching may occur after formatting, and thus the website provider may use the formatting to convert identity repository values into the values that are used by the particular website for multiple choice options, such as a credit card type.

These particular examples using HTML and JavaScript are merely exemplary and not meant to be limiting. Other website formats and coding languages may be used to implement similar ideas by one having skill in the art after reading this disclosure.

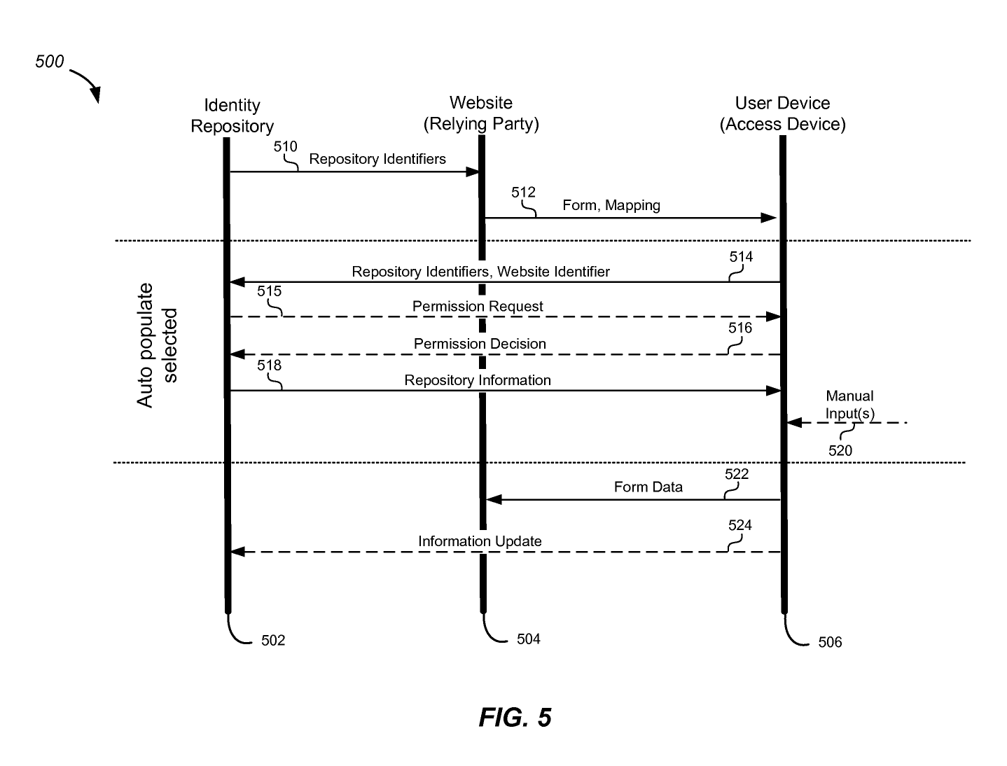

FIG. 5 illustrates a simplified swim diagram 500 of transactions that may be involved with populating fields in an electronic form, according to one embodiment. Swim diagram 500 is representative of one particular embodiment. It will be understood that the transactions depicted in swim diagram 500 may be rearranged, omitted, replaced, broken into sub transactions, or combined according to the particular embodiment. Swim diagram 500 is used merely to provide an enabling disclosure and is not meant to be limiting.

Swim diagram 500 may represent a part of a retail transaction where a relying party website requests information from a user device using the electronic form. The identity repository 502 may provide a standard list of repository identifiers to the relying party website 504 (510). Using the repository fields, the relying party website 504 may generate a mapping between the repository fields and the form fields using the repository identifiers and the field identifiers. In some cases, the mapping may be generated prior to the electronic form being provided. In other cases, the mapping may be generated on demand when the form is provided by the relying party website 504 or when a user selects an auto fill input on the webpage.

The relying party website 504 may then transmit the form and/or the mapping to the user device 506 (512). In terms of the identity management system described earlier, the user device 506 may be considered an access device. The user device 506 may also be considered a control device. The user device 506 may then automatically attempt to populate the electronic form using information from the identity repository 502, or the user device 506 may do so in response to an input from a user, such as selecting an auto fill input on the webpage.

Next, the user device 506 may send a list of repository identifiers to the identity repository 502 (514). In some embodiments, the user device 506 may also send a website identifier to the identity repository 502 (514). The identity repository 502 may use the website identifier to determine whether a permission has been previously granted and/or stored to release this information to the website 504. In some embodiments, permission may be granted to release any information to a particular website 504. In some embodiments, a permission maybe granted to release only some information to the website 504.

In some embodiments, the identity repository may determine whether permission is granted to release a certain type of data based on a transaction type. For example, a commercial transaction could have permission to release credit card information, a shipping address, and contact information, while it would not release information such as a birth date or a Social Security Number. In contrast, a banking transaction may release information, such as an account number and the last four digits of a Social Security number, but not a shipping address. Transaction types may be mapped to permissions by a user and stored at the identity repository 502. Alternatively, the identity repository may create default permission classes that can be overridden by user permissions.

If it is determined that permission has not been granted for the website 504 to receive a particular type of data needed to populate the electronic form, the identity repository 502 may request permission from the user device 506 (515). Permission may be granted by the user device 506 and transmitted to the identity repository 502 (516). In some embodiments, permission may be granted using a salted PIN or password that is encrypted at the user device 506 and compared to an encrypted dictionary value at the identity repository 502. This may allow the identity repository 502 to authenticate the user of the user device 506 without storing a PIN or password in an accessible form at the identity repository 502.

The identity repository 502 may locate information associated with the repository identifiers and send the repository information to the access device 506 (518). The repository information may be sent in response to determining that permission is granted to release the information to the website 504.

In some embodiments, the identity repository 502 may comprise a completely encrypted repository where all of the user information stored thereon is in an encrypted form. The cryptographic keys that can be used to access the encrypted data may be required to be stored on the user device 506. This may separate the encrypted information from the means by which it may be accessed for additional security. This arrangement is described in relation to the identity management system described earlier. In these embodiments, the encrypted information stored at the identity repository 502 may be in the form of encrypted identifier/value pairs. In this case, the user device 506 may encrypt each repository identifier requested by the electronic form and send the encrypted repository identifiers to the identity repository 502. The identity repository may then look up the encrypted values using the encrypted repository identifiers. The identity repository 502 may then send the encrypted values to the access device 506, where they can be decrypted using the locally-stored cryptographic key. The decrypted information may then be used to populate the electronic form.

If necessary, manual inputs may also be received by the user device 506 from a user (520). Also, additional inputs may be received from a web browser using locally stored personal information (not shown). Once an electronic form is sufficiently populated, the form data may be sent to the website 504. In some embodiments, the electronic form need not be completely populated, and only a subset of required fields may be required for the form data to be sent to the website 504. In some embodiments, any information populated in the electronic form can be sent regardless of whether all required fields were populated.

In some embodiments, the user device 506 may detect form data that was populated manually or using locally stored personal information. The user device 506 may then transmit the manually-entered or locally-stored information to the identity repository 502 for storage. In some embodiments, this new information may be encrypted in identifier/value pairs as described above before it is sent to the identity repository 502. This may allow future requests to populate an electronic form to be completed using identity repository information exclusively, and may allow users to remove locally stored information from the user device 506 for enhanced security.

What follows next is a series of methods for populating an electronic form from the perspective of each device in the transaction, including the user device, the website, and the identity repository. The features of the various embodiments described above may be applied to the methods below in any combination that would meet the needs of a particular operating environment. For example, the method described below for populating an electronic form on a user device may include any of the features described in relation to any of the other figures or descriptions found elsewhere in this disclosure. The exact steps described below are not meant to be limiting.

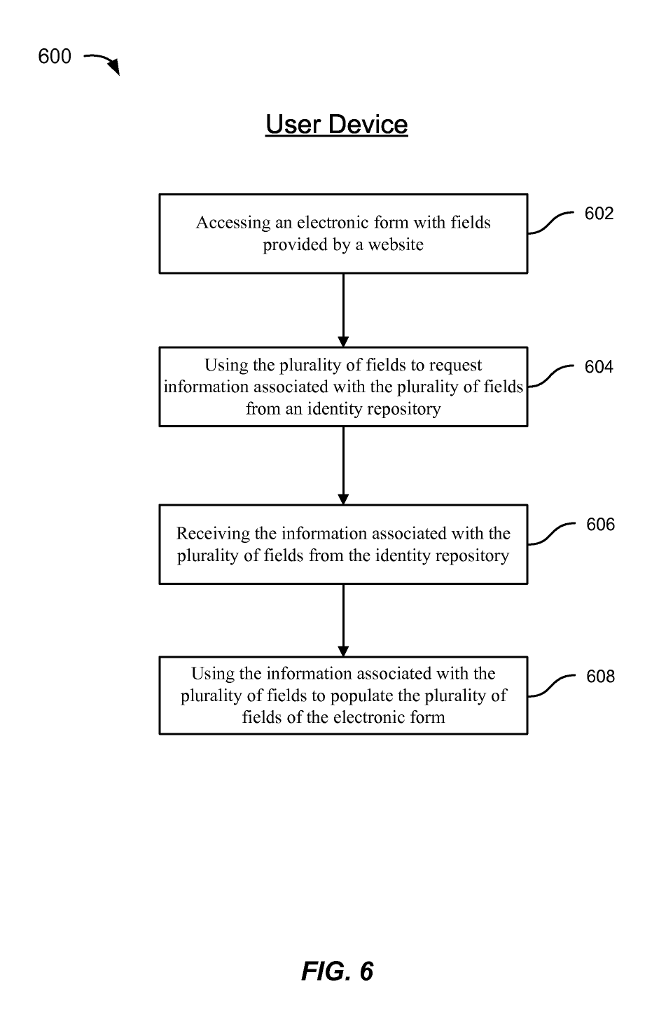

FIG. 6 illustrates a simplified flowchart 600 of a method of populating an electronic form from the perspective of a user device, according to one embodiment. The method may include accessing an electronic form provided by a website (602). In some embodiments, the electronic form may comprise a plurality of fields. The plurality of fields may be associated with particular input controls on the electronic form.

In some embodiments, the website may also provide a mapping that associates the plurality of fields to a plurality of repository fields from an identity repository. The mapping may be provided by the website and generated by the operator of the website. The mapping may also comprise a default mapping that is stored locally on the user device or retrieved from the identity repository. In some embodiments, a mapping need not be necessary if the website has named and formatted fields such that they match the repository identifiers and formats provided by the identity repository. In this case, the user device may simply use the field identifiers associated with the plurality of fields on the electronic form as the repository identifiers to retrieve information from the identity repository.

The method may also include using the plurality of fields to request information associated with the plurality of fields from the identity repository (604). In some embodiments, this may include encrypting a plurality of repository identifiers. The plurality of repository identifiers may be provided in the mapping from the website or any of the other ways described above. The encrypted repository identifiers may then be sent to the identity repository.

In some embodiments, the method may optionally include receiving a request for permission from the identity repository to release the requested information to the particular website. The user device may also respond by sending permission to the identity repository or, alternatively, refusing to grant permission. Granting or refusing permission may be accompanied by some form of a digital signature authenticating the user or the user device.

The method may also include receiving the information associated with the plurality of fields from the identity repository (606). The information received from the identity repository may be encrypted and only accessible using a cryptographic key stored locally on the user device. In some embodiments, the user device made decrypt the information received and use the decrypted information to populate the electronic form.

In some embodiments, the user device may also receive an input from a user for one or more of the plurality of fields. This may occur in cases where the information retrieved from the identity repository was not sufficient to populate the electronic form. In some embodiments, the user may manually edit information provided by the identity repository. For example, the user may realize that an e-mail or a home address is out of date as provided by the identity repository. The user may update the address or email in the electronic form. The user device may determine that the input from the user is different from the information provided by the identity repository and provide input from the user to the identity repository to be stored in place of at least a part of the information provided. For example, an updated address may be sent and stored as a replacement home address in the identity repository, possibly in an encrypted form.

The method may also include using the information associated with the plurality of fields to populate the plurality of fields of the electronic form (608). In some embodiments, the information may visibly be displayed in the form fields on a screen of the user device. In other embodiments, and HTML POST response may be generated and sent to the website without visibly filling in text boxes on the display. In some embodiments, this may happen automatically without human intervention, such that the user device automatically determines that the information sufficiently populates the plurality of fields of the electronic form and automatically submits the information to the website.

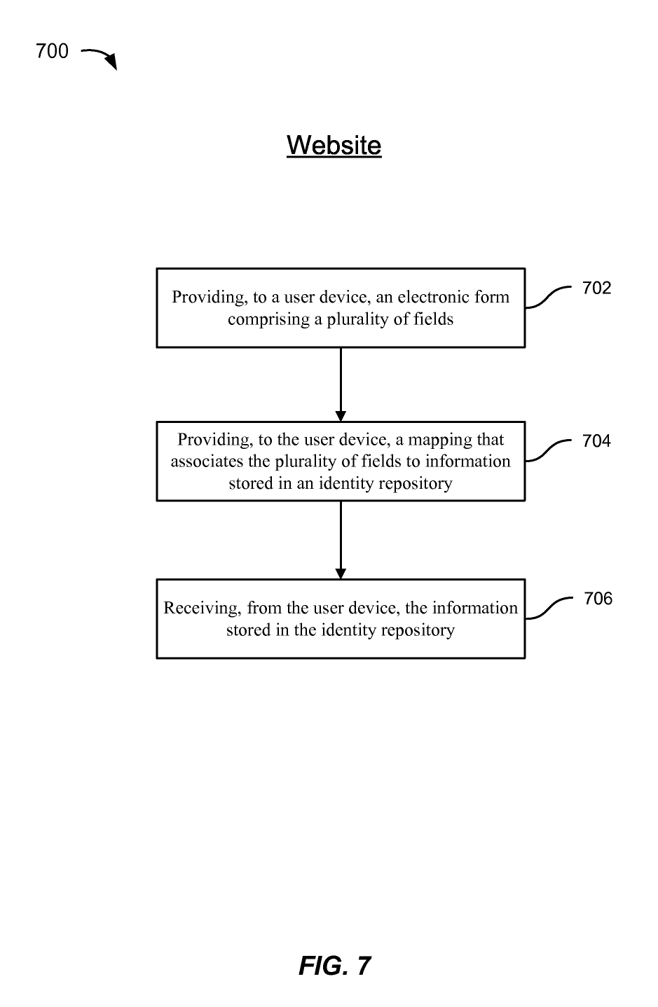

FIG. 7 illustrates a simplified flowchart 700 of a method of populating an electronic form from the perspective of a website, according to one embodiment. The method may include providing an electronic form comprising a plurality of fields (702). The electronic form may be provided to a user device. The user device may request the electronic form from a web server that is configured to retrieve and process user information from the electronic form. The electronic form may include an auto fill button configured to automatically populate the electronic form using identity repository information.

The method may also include providing a mapping that associates the plurality of fields to information stored in the identity repository (704). The mapping may be provided to the user device as a separate file, as a part of the electronic form, or as a part of a website hosting the electronic form. In some embodiments, the mapping may associate the plurality of fields to a plurality of repository fields provided by the identity repository. Specifically, the mapping may associate field identifiers to repository identifiers such as HTML names or tags and/or XML elements and attributes. The mapping may be generated prior to providing the electronic form. The mapping may be generated by an automatic process or may be generated manually by an operator. In some embodiments, an automated process may operate at the web server and automatically detect any changes to the repository identifiers made public by the identity repository. When changes are detected, the automated process may change the mapping to reflect the current repository identifiers used by the identity repository.

The method may also include receiving the information stored in the identity repository (706). The information may be received as part of a submit process for the electronic form. In some embodiments, the electronic form may be configured to graphically highlight fields that are populated with the information stored in the identity repository. Alternatively, the electronic form may be configured to graphically highlight fields that are not populated with the information stored in the identity repository. Some embodiments may automatically process the electronic form in response to receiving the data stored in the identity repository. Some embodiments may also send a notification to the identity repository that the data was received and used to populate the electronic form. This tracking may be done for statistical purposes.

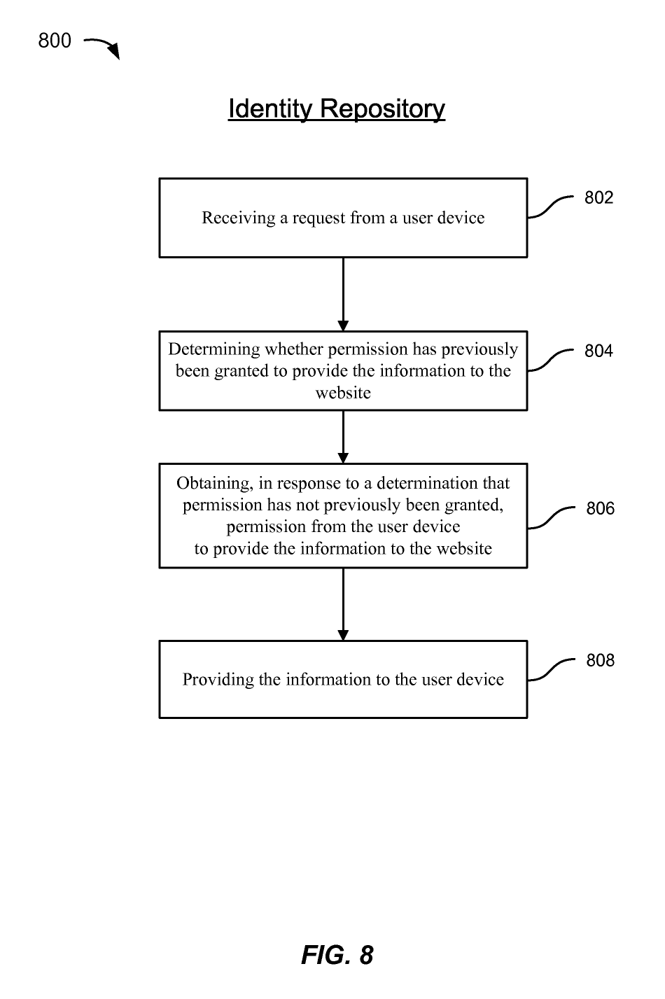

FIG. 8 illustrates a simplified flowchart of a method of populating an electronic form from the perspective of an identity repository, according to one embodiment. The method may include receiving a request from a user device (802). In some embodiments, the request may comprise a request for information associated with fields of an electronic form. In some embodiments, the identity repository may also receive an identifier of a website providing the electronic form to the user device. The request for information may comprise a set of encrypted repository identifiers that relates information stored at the identity repository to form fields using a mapping provided by the website. In other embodiments, the mapping may be stored locally on the identity repository or provided by the user device.

The identity repository may be geographically remote from the user device. The identity repository can be located in a facility and on computer equipment that is separate and distinct from a facility or computer equipment associated with the user device. In some embodiments, the identity repository may be separated from the user device by at least 5 miles, at least 10 miles, at least 25 miles, and so forth.

The method may also include determining whether permission has previously been granted to provide information to the website (804). If permission has not been previously granted, the identity repository may send a permission request to the user device. In response, the user device may either grant permission or withhold permission (806). The permission decision may be provided along with a digital signature, such as a salted password or PIN using elliptical curve encryption. The digital signature may be verified by the identity repository by using an inverse elliptical curve encryption function and a secret salt value that is shared between the user device and the identity repository. The details of password verification are described thoroughly in U.S. patent application Ser. No. ______, filed Jan. ______, 2013, entitled “Methods and Systems for Pairing Devices” (Attorney Docket No. 94276-847941(000710USNP)), which is incorporated by reference for all purposes as stated above.

The method may additionally include providing the information to the user device (808). In some embodiments the information may be part of an encrypted identifier/value pair. The information may be encrypted at all times while stored on the identity repository. The value component of the identifier/value pair may be provided in an encrypted form to the user device, where it can be decrypted using a cryptographic key stored on the user device and unavailable to the identity repository.

In some embodiments, the user device or the website may send the identity repository new information provided by the user when populating the electronic form. This information may supplement or replace information provided by the identity repository. In response, the identity repository may store the new information in the user account as an encrypted identifier/value pair.

It should be appreciated that the specific steps illustrated in FIGS. 6-8 provide particular methods of securely populating an electronic form according to various embodiments of the present invention. Other sequences of steps may also be performed according to alternative embodiments. For example, alternative embodiments of the present invention may perform the steps outlined above in a different order. Moreover, the individual steps illustrated in FIGS. 6-8 may include multiple sub-steps that may be performed in various sequences as appropriate to the individual step. Furthermore, additional steps may be added or removed depending on the particular applications. One of ordinary skill in the art would recognize many variations, modifications, and alternatives.

Turning briefly back to FIG. 2, the identity repository, website, and the user device of the embodiments described herein may correspond to the identity repository, relying party, and access device of the identity management system. The transactions involving digital signatures PIN and passwords verification, device registration, out-of-band authorization, control devices, and secure identity management may be combined with these methods of securely populating an electronic form.

However, it will be understood that the secure transaction subsystem and the electronic form population methods described herein are not restricted solely to the identity management system described herein. In fact, these principles can be used in a number of different applications, such as protecting credit card data, financial data, banking transactions, e-mail, data communications, and/or the like. Furthermore, every aspect of the identity management system described herein may benefit from these methods of populating an electronic form. Various embodiments not describe explicitly herein for brevity may rearrange the features described herein according to the needs of each application. One having skill in the art could rearrange the functionalities described above within the identity management system in light of the disclosure.

### Exemplary Hardware

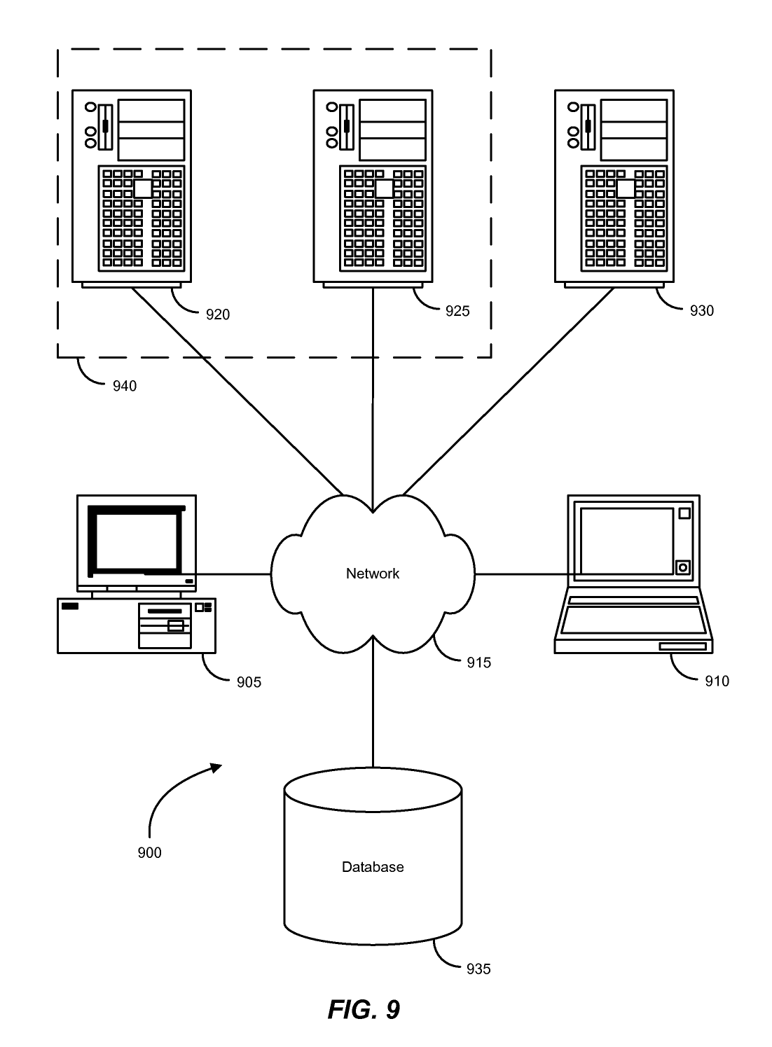

Each of the embodiments disclosed herein may be implemented in one or more computer systems. The computer systems can communicate with each other through a network. FIG. 9 is a block diagram illustrating components of an exemplary operating environment in which various embodiments of the present invention may be implemented. The system 900 can include one or more user computers 905, 910, which may be used to operate a client, whether a dedicated application, web browser, etc. The user computers 905, 910 can be general-purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 905, 910 may also have any of a variety of applications, including one or more development systems, database client and/or server applications, and web browser applications. Alternatively, the user computers 905, 910 may be any other electronic device, such as a thin-client computer, Internet-enabled mobile telephone, and/or personal digital assistant, capable of communicating via a network (e.g., the network 915 described below) and/or displaying and navigating web pages or other types of electronic documents. Although the exemplary system 900 is shown with two user computers, any number of user computers may be supported.

In some embodiments, the system 900 may also include a network 915. The network may can be any type of network familiar to those skilled in the art that can support data communications using any of a variety of commercially-available protocols, including without limitation TCP/IP, SNA, IPX, AppleTalk, and the like. Merely by way of example, the network 915 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 920, 925, 930 which can be general-purpose computers and/or specialized server computers (including, merely by way of example, PC servers, UNIX servers, mid-range servers, mainframe computers rack-mounted servers, etc.). One or more of the servers (e.g., 930) may be dedicated to running applications, such as a business application, a web server, application server, etc. Such servers may be used to process requests from user computers 905, 910. The applications can also include any number of applications for controlling access to resources of the servers 920, 925, 930.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 905, 910. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 905, 910.

In some embodiments, an application server may create web pages dynamically for displaying on an end-user (client) system. The web pages created by the web application server may be forwarded to a user computer 905 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 900 may also include one or more databases 935. The database(s) 935 may reside in a variety of locations. By way of example, a database 935 may reside on a storage medium local to (and/or resident in) one or more of the computers 905, 910, 915, 925, 930. Alternatively, it may be remote from any or all of the computers 905, 910, 915, 925, 930, and/or in communication (e.g., via the network 920) with one or more of these. In a particular set of embodiments, the database 935 may reside in a storage-area network (“SAN”) familiar to those skilled in the art. Similarly, any necessary files for performing the functions attributed to the computers 905, 910, 915, 925, 930 may be stored locally on the respective computer and/or remotely, as appropriate. In one set of embodiments, the database 935 may be a relational database, such as Oracle 10g, that is adapted to store, update, and retrieve data in response to SQL-formatted commands.

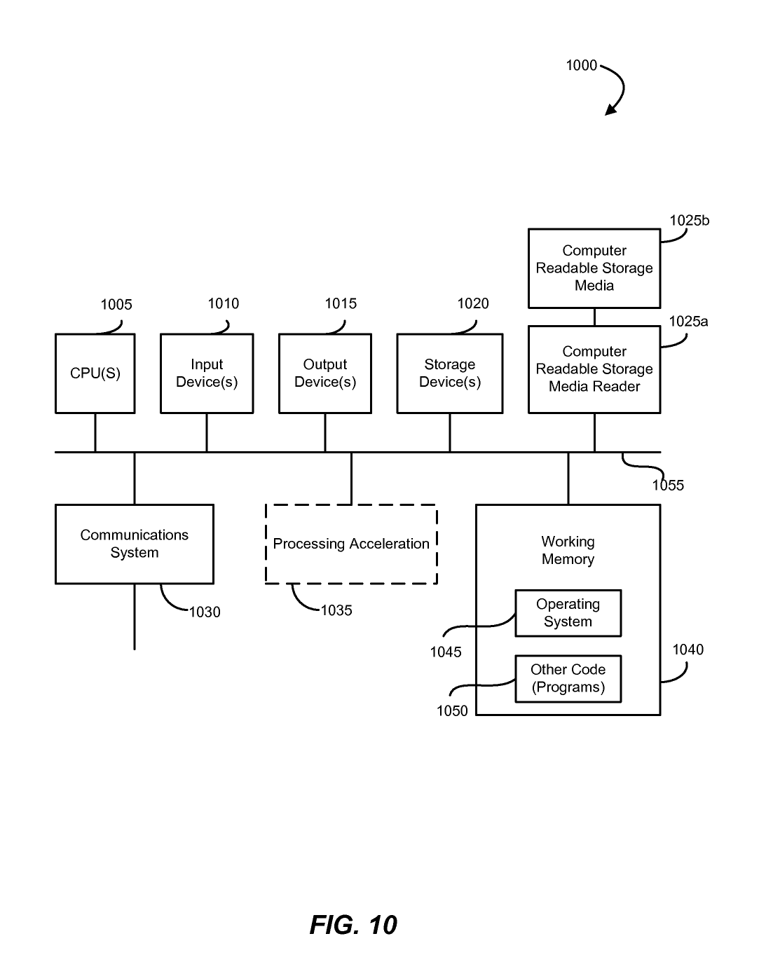

FIG. 10 illustrates an exemplary computer system 1000, in which various embodiments of the present invention may be implemented. The system 1000 may be used to implement any of the computer systems described above. The computer system 1000 is shown comprising hardware elements that may be electrically coupled via a bus 1055. The hardware elements may include one or more central processing units (CPUs) 1005, one or more input devices 1010 (e.g., a mouse, a keyboard, etc.), and one or more output devices 1015 (e.g., a display device, a printer, etc.). The computer system 1000 may also include one or more storage device 1020. By way of example, storage device(s) 1020 may be disk drives, optical storage devices, solid-state storage device such as a random access memory (“RAM”) and/or a read-only memory (“ROM”), which can be programmable, flash-updateable and/or the like.

The computer system 1000 may additionally include a computer-readable storage media reader 1025a, a communications system 1030 (e.g., a modem, a network card (wireless or wired), an infra-red communication device, etc.), and working memory 1040, which may include RAM and ROM devices as described above. In some embodiments, the computer system 1000 may also include a processing acceleration unit 1035, which can include a DSP, a special-purpose processor and/or the like.

The computer-readable storage media reader 1025a can further be connected to a computer-readable storage medium 1025b, together (and, optionally, in combination with storage device(s) 1020) comprehensively representing remote, local, fixed, and/or removable storage devices plus storage media for temporarily and/or more permanently containing computer-readable information. The communications system 1030 may permit data to be exchanged with the network 1020 and/or any other computer described above with respect to the system 1000.

The computer system 1000 may also comprise software elements, shown as being currently located within a working memory 1040, including an operating system 1045 and/or other code 1050, such as an application program (which may be a client application, web browser, mid-tier application, RDBMS, etc.). It should be appreciated that alternate embodiments of a computer system 1000 may have numerous variations from that described above. For example, customized hardware might also be used and/or particular elements might be implemented in hardware, software (including portable software, such as applets), or both. Further, connection to other computing devices such as network input/output devices may be employed. Software of computer system 1000 may include code 1050 for implementing embodiments of the present invention as described herein.

The following methods may be implemented by a computer system, such as computer system 1000 in FIG. 10. Each step of these methods may be done automatically by the computer system, and/or may be provided as inputs and/or outputs to a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Therefore, it will be understood in light of this disclosure, that each step and each method described herein may be altered to include an input and output to and from a user, or may be done automatically by a computer system.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of populating form data, the method comprising:
accessing an electronic form provided by a website, wherein the electronic form comprises a plurality of fields;
using the plurality of fields to request information associated with the plurality of fields from an identity repository;
receiving the information associated with the plurality of fields from the identity repository; and
using the information associated with the plurality of fields to populate the plurality of fields of the electronic form.

2. The method of claim 1 further comprising using a mapping to associate the plurality of fields to a plurality of repository fields.

3. The method of claim 2 wherein the mapping is provided by the website.

4. The method of claim 2 wherein the mapping comprises a default mapping stored locally or at the identity repository.

5. The method of claim 1 further comprising:
encrypting a plurality of repository identifiers that are used to that associate the plurality of fields with the information, wherein the plurality of repository identifiers are provided in a mapping by the website; and
sending the encrypted plurality of repository identifiers to the identity repository.

6. The method of claim 1 further comprising:
receiving an input from a user for one or more of the plurality of fields;
determining that the input from the user is different from the information; and
providing the input from the user to the identity repository to be stored in place of at least part of the information.

7. The method of claim 1 further comprising:
receiving a request from the identity repository to grant permission to release the information to the website; and
sending a digital signature to the identity repository with a permission to release the information to the website.

8. The method of claim 1 further comprising:
determining that the information sufficiently populates the plurality of fields of the electronic form; and
submitting the information to the website.

9. A method of populating form data, the method comprising:
providing, to a user device, an electronic form comprising a plurality of fields;
providing, to the user device, a mapping that associates the plurality of fields to information stored in an identity repository;
receiving, from the user device, the information stored in the identity repository.

10. The method of claim 9 further comprising providing an auto fill button on a website.

11. The method of claim 9 further comprising graphically highlighting fields that are populated with the information stored in the identity repository.

12. The method of claim 9 further comprising graphically highlighting fields that are not populated with the information stored in the identity repository.

13. The method of claim 9 wherein the mapping associates the plurality of fields to a plurality of repository fields provided by the identity repository.

14. The method of claim 9 further comprising automatically processing the electronic form in response to receiving the information stored in the identity repository.

15. The method of claim 9 further comprising sending a notification to the identity repository that the information stored in the identity repository was used to populate the electronic form.

16. A method of populating form data by an identity repository, the method comprising:
receiving, from a user device:
a request for information associated with fields of an electronic form, and
an identifier of a website providing the electronic form to the user device;
determining whether permission has previously been granted to provide the information to the website;
obtaining, in response to a determination that permission has not previously been granted, permission from the user device to provide the information to the website; and
providing the information to the user device.

17. The method of claim 16 wherein the identity repository is geographically remote from the user device.

18. The method of claim 16 wherein:
the information is encrypted while stored on the identity repository;
the information is provided to the user device in an encrypted form; and
the information is decrypted by the user device.

19. The method of claim 16 further comprising:
receiving new information provided by a user of the user device when populating the electronic form; and
storing the new information in an account associated with the user.

20. The method of claim 16 providing the website with a plurality of repository identifiers to generate a mapping that associates the plurality of repository identifiers with a plurality of field identifiers.
